(19) United States
(12) Patent Application Publication
(10) Pub. No.: US 2018/0266567 A1
(43) Pub. Date: Sep. 20, 2018

(54) ENERGIZED PTFE SEAL FOR BUTTERFLY VALVE

(71) Applicant: Nor-Cal Products, Inc., Yreka, CA (US)

(72) Inventors: Jeff Hadley, Yreka, CA (US); Sean Casarotti, Yreka, CA (US)

(21) Appl. No.: 15/642,101

(22) Filed: Jul. 5, 2017

Related U.S. Application Data
(60) Provisional application No. 62/471,137, filed on Mar. 14, 2017.

(51) Int. Cl. F16K 1/226; F02D 9/10

(52) U.S. Cl. CPC F16K 1/2268; F02D 9/108; F02D 9/1015; F16K 1/2263; F16K 1/2261

(57) ABSTRACT

A plate within the valve pivots about a shaft to cause the plate to transition between an open position and a closed position within a bore passing through the housing of the valve. The plate has a perimeter seal thereon which abuts against a tapering seat of the bore when the throttle plate is in a closed orientation. The seal has a curving form over a recess and an energy source, such as the toroidal spring in the recess, to energize the seal and allow it to maintain secure contact against the seat. The shaft is offset from the centerline of the bore and the plate is mounted to the shaft at a location offset from the center point of the plate, so that rotation of the plate causes the plate to swing somewhat into a closed position, minimizing abrasive contact between the seat and seal during closing.

### CROSS-REFERENCE TO RELATED APPLICATIONS

This application claims benefit under Title 35, United States Code § 119(e) of U.S. Provisional Application No. 62/471,137 filed on Mar. 14, 2017.

### FIELD OF THE INVENTION

The following invention relates to valves generally in the form of butterfly valves which include seals at a perimeter thereof which seal to a surrounding wall. More particularly, this invention relates to valves, such as throttling butterfly valves, particularly for use in vacuum handling equipment, which include energized seals for robust sealing at various different gas pressure differentials across the valve, and which feature a pivot shaft offset from a center of a valve plate and offset from a centerline of a bore in which the valve plate is located.

### BACKGROUND OF THE INVENTION

Vacuum handling equipment, including chambers, conduits, valves and pumps, as well as related equipment, are used in a variety of industries including certain specialized forms of manufacturing and in scientific research where vacuum is required. Some process chambers and other chambers within vacuum assemblies require that a controlled low pressure within a particular range be maintained. One convenient arrangement for controlling pressure within such a chamber is to position a throttling valve between the chamber and a vacuum pump. Pressure in the space between the throttling valve and the vacuum pump will be lower than pressure within the chamber. By appropriate actuation of the throttling valve, flow from the chamber toward the vacuum pump is controlled and desired low pressure within the chamber maintained. A pressure sensor can be provided within the chamber and coupled to a controller on the throttling valve to provide a throttling control valve which automatically senses pressure within the chamber and makes adjustments to the throttling valve so that pressure within the chamber is maintained within a desired (typically very low) range.

One type of throttling control valve which provides desirable valve control characteristics is a butterfly valve. Such butterfly valves for chamber pressure control, and potentially for other uses within vacuum assemblies, include a throttle plate which is generally planar and with a shaft oriented within this plane to which the throttle plate is attached. The shaft rotates, based on input from a controller of some type, to cause the plate to transition from closing the valve to opening the valve in a process referred to as “throttling.”

When the valve is throttling or alternating into the closed position, contact is encountered between an edge of the seal on a perimeter of the throttle plate or other valve element and adjacent side walls. Often it is desirable to have a tight seal at this junction, such as during initial pump down of a high vacuum process chamber adjacent to the throttling butterfly valve. Any leakage around a perimeter of such a seal can have a significant impact on such “pump down” times, and undesirably affect duty cycle for the overall process equipment. Accordingly, a need exists for a throttling butterfly valve with a perimeter seal that can tightly seal with a surrounding wall in a reliable and repeatable fashion, especially when a large pressure differential is being held by the valve in a closed state, and which also has desirable characteristics such as to minimize sliding of seal elements relative to the wall.

### SUMMARY OF THE INVENTION

The valve of this invention can, in one embodiment include some characteristics similar to those described in U.S. patent application Ser. No. 14/857,599, incorporated herein by reference in its entirety.

In essence, the valve includes a throttle plate or other valve plate which pivots on a shaft between an open and a closed position, a perimeter of the throttle plate of the valve is formed of PTFE (“PolyTetraFluoroEthylene”) or analogous material, such as metal, plastic or rubber. This PTFE seal has a unique geometry and is also energized so that it has a non-deflected semi-cylindrical form which also curves annularly about the perimeter of the preferably circular valve plate, generally in the nature of a butterfly valve throttle plate. This geometry is maintained by an energy source, such as a spring or series of springs, or by forming the material with sufficient elasticity so that it acts itself as a spring. With the seal member appropriately energized, significant pressure differential across the valve can be withstood (typical pressure range for control by the valve is between vacuum and 30 psia) without significant leakage past the seal element.

The seal element can be referred to by applicant as a J-LOCK seal in that it has somewhat of a shape similar to that of a capital letter “J” (see FIG. 4). The J-LOCK seal thus includes a long leg opposite a short leg and with a tooth on an end of the short leg. The long leg is captured between two plate halves which are sandwiched together to form the throttle plate of the throttling butterfly valve. This long leg transitions into a semi-circular section which curves approximately 180° about a central radius origin point until it transitions into the short leg. The short leg is exceptionally short, or even is merely the end of the semi-circular segment opposite the long leg. This short leg is generally parallel with the long leg.

A tooth extends perpendicularly from the tip of the short leg and perpendicular to the long leg with the tooth extending away from the long leg. The throttle plate or other valve plate is preferably formed of two parallel plates. One of the plates adjacent the short leg includes a lip overlying a recess with the tooth fitting within the recess and beneath the lip. The tooth and short leg are thus captured to the valve plate. The tooth that extends off of the short leg of the “J” allows the seal to be retained and prevents pullout of the leading edge of the seal in contaminated environments.

The long leg is captured by sandwiching between the plates. The long leg of the “J” is used to locate and retain position of the semi-circular section of the seal. The diameter of the semi-circular section can in one embodiment range from 0.030 inches to 0.5 inches.

The semi-circular section preferably surrounds a toroidal recess and is preferably energized with an energy source. In one embodiment this energy source is a spring or series of springs inboard of a perimeter of the J-LOCK seal on a perimeter of the valve element and encapsulated within the recess on three sides by the interior surface of the seal. Such springs could be resilient mass springs or helical compression springs, either extending circumferentially and with a toroidal slope or as a series of radially extending short linear compression springs, or other types of springs known in the art. Other forms of resilient masses could fill the recess inboard of the semi-circular section and function as the energy source of the seal. It is also conceivable that air or other gas could be contained within this space inboard of the semi-circular section which might act as a sufficient energy source when merely provided at atmospheric pressure, when compared to the near atmospheric pressure existing outside of the J-LOCK seal. As another option, a solid O-ring could merely fill the recess inboard of the semi-circular section with an O-ring formed of a resilient material and acting as such a spring.

The valve body wall against which the seal abuts when closed defines a seat and is also formed with a particular geometry including a contour where contact occurs with the J-LOCK seal's semi-circular section outer surface. Thus, two surfaces come into contact with each other, limiting this contact to a small area to minimize seal wear by PTFE seal material (or other seal material) coming into contact with the valve body wall which is typically formed of metal, for a shorter percentage of each stroke of the valve. The rounded shape of the seal at the semi-circular section, coupled with the offset shaft in the body (discussed below) ensures that the seal pulls away from the body wall quickly. This reduces wear of the seal. The seal surface in the valve body wall provides a gradual compression to the seal and reduces wear.

A hub upon which the valve element rotates is preferably offset from a centerline of the throttle plate. Thus, the perimeter of the seal follows a somewhat unique path which beneficially causes the seal to quickly come into contact with seating portions of the adjacent valve body wall in a manner which minimizes abrasive contact, but rather facilitates resting of the wall of the seal to come against a side wall in a manner that minimizes abrasiveness.

### OBJECTS OF THE INVENTION

Accordingly, a primary object of the present invention is to provide a valve which can provide a robust seal to maintain a high vacuum environment on an upstream side of the seal.

Another object of the present invention is to provide a throttling butterfly vacuum valve which has a perimeter seal which minimizes abrasive contact when closing and maintains a secure seal at the perimeter.

Another object of the present invention is to provide a valve which maintains a high quality seal both under low vacuum and low pressure differential conditions, as well as when a pressure differential similar to atmospheric pressure is encountered.

Another object of the present invention is to provide a throttling butterfly valve for high vacuum gas handling which provides precise control for maintenance of desired pressure, especially within a test chamber upstream of the valve.

Another object of the present invention is to provide a method for maintaining a strong seal at a perimeter of a butterfly valve.

Another object of the present mention it to provide a valve with an offset shaft upon which a valve plate thereof is pivotably attached, such that abrasive contact between a perimeter seal of the valve plate and a seat against which the seal rests, can be optimized.

Other further objects of the present invention will become apparent from a careful reading of the included drawing figures, the claims and detailed description of the invention.

### BRIEF DESCRIPTION OF THE DRAWINGS

FIG. 1 is a top plan full sectional view of the valve of this invention according to a first embodiment and with the valve plate thereof shown in a fully open orientation.

FIG. 2 is a top plan full sectional view similar to that which is shown in FIG. 1, but with the valve plate shown almost closed.

FIG. 3 is a top plan full sectional view similar to that which is shown in FIGS. 1 and 2, but with the valve plate shown fully closed.

FIG. 4 is a detail of a portion of that which is shown in FIG. 2, illustrating details of a perimeter seal and energizing spring provided according to one embodiment of this invention.

FIG. 5 is a detail of a portion of that which is shown in FIG. 3 and corresponding with FIG. 4, showing the perimeter seal and spring after the perimeter seal has been compressed by abutting against the seat of the valve.

FIG. 6 is a top plan full sectional view similar to that which is shown in FIG. 3, and illustrating how the valve plate is pivotably mounted upon a shaft which is offset relative to a center of the valve plate and relative to a centerline of the bore in which the valve plate acts.

FIG. 7 is a side elevation full sectional view of that which is shown in FIG. 6.

FIG. 8 is a top plan full sectional view of a vacuum system in which the valve of FIG. 1 of this invention is incorporated.

### DESCRIPTION OF THE PREFERRED EMBODIMENT

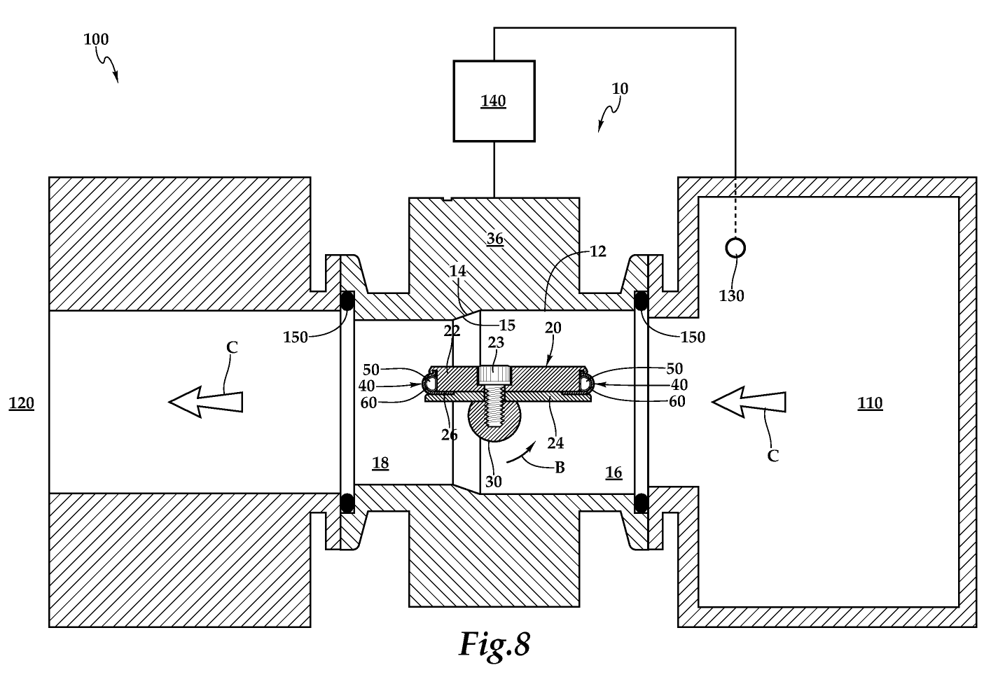

Referring to the drawings, wherein like reference numerals represent like parts throughout the various drawing figures, reference numeral 10 is directed to a valve (FIG. 8), particularly configured for use in handling high vacuum, such as upstream of a vacuum pump 120 and downstream of a high vacuum region, such as a vacuum process chamber 110 within a vacuum handling system 100. The valve 10 is configured with an offset shaft 30 orientation and with an energized perimeter seal 40 to provide a high quality seal and minimize disruption of the vacuum environment adjacent thereto.

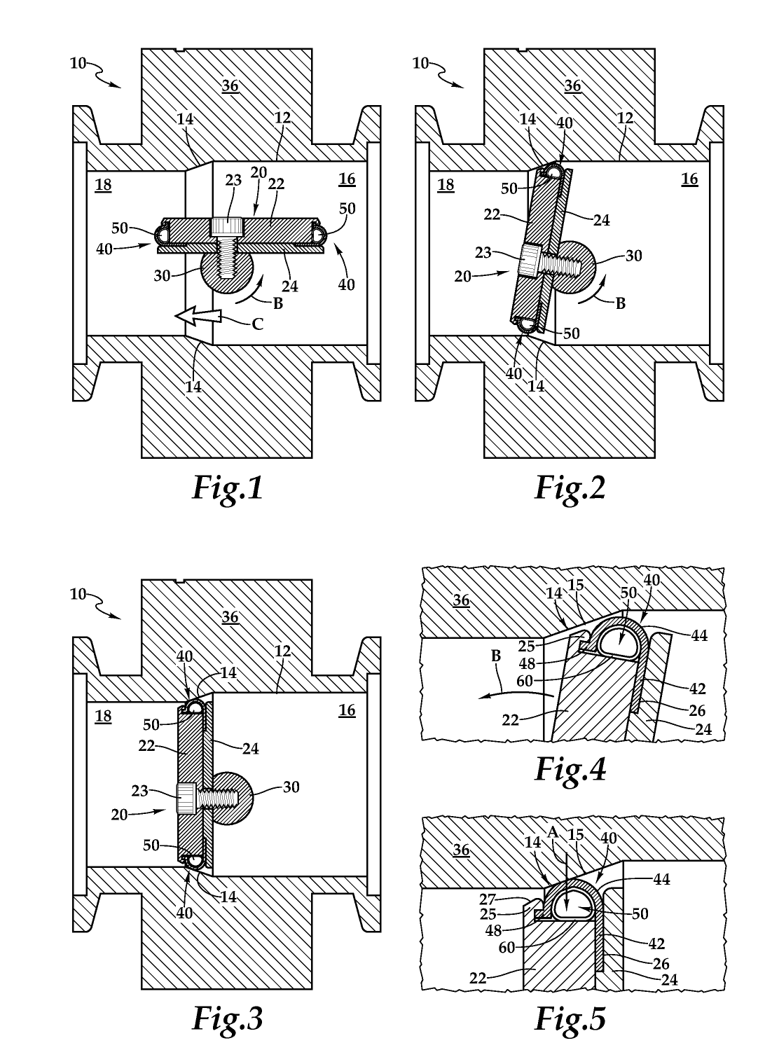

In essence, and with particular reference to FIGS. 1-3, 6 and 7, basic details of the valve 10 are described, according to a preferred embodiment. The valve 10 fits within a housing 36 having a bore 16, 18 passing therethrough. The valve 10 includes a throttle plate 20 which is pivotably attached within the housing 36 to selectively open and close passage through the bore 16, 18. The throttle plate 20 is preferably mounted upon an offset shaft 30 about which the throttle plate 20 rotates between an open position and a closed position. The perimeter of the throttle plate 20 includes a perimeter seal 40 thereon. This perimeter seal 40 is preferably configured to be energized so that it maintains a tight seal with a body wall of the bore 16, 18 passing through the housing 36 of the valve 10, when the throttle plate 20 is in a closed position and with the perimeter seal 40 abutting against a seat 14 in the body wall 12. In one embodiment, this seal 40 surrounds a recess 50. This recess 50 can include a force applying structure which applies a radially outward force through the seal to keep the seal intimately contacting the seat 14 when the throttle plate 20 is in the closed orientation. One form of force applying structure to energize the seal is to include a spring 60, such as a toroidal spring, within this recess 50 inboard of the perimeter seal 40.

More specifically, and with particular reference to FIGS. 1, 2 and 8, particular details of the housing 36 and bore 16, 18 passing therethrough, as well as details of where the throttle plate 20 is located, are described, according to this most preferred embodiment. The valve 10 has a housing in the form of an airtight perimeter wall surrounding a central bore 16, 18 passing through the valve 10. The housing 36 is typically a monolithic stainless steel (or other material) block machined or otherwise formed to have a contour such as that shown.

The central bore 16, 18 includes a large bore portion 16 and a smaller bore portion 18 which has a smaller diameter than the large bore portion 16. Typically, the side of the valve 10 which is to maintain a desired vacuum is on the large bore portion 16 side of the valve 10. Preferably, a center of the valve 10 has a seat 14 located in a body wall 12 of the bore 16, 18 which is located at a transition between the larger bore portion 16 and the smaller bore portion 18. The seat 14 preferably has an angled surface 15 (FIGS. 4 and 5) which is frusto-conical in form, against which the seal 40 of the perimeter of the throttle plate 20 rests when the perimeter seal 40 is rotated into a closed position. This surface 15 of the seat 14 has an angle away from the body wall 12 adjacent to the larger bore portion 16 which has an angle θ associated therewith of typically approximately 30°, but which could be slightly greater, such as 45° or 60°, or slightly less, such as approximately 15° (FIG. 6).

The portions 16, 18 of the bore each have a circular cross-section in a preferred embodiment of this invention, so that the seat 14 is also annular in form and so that the seat 14 is actually a frusto-conical section of the body wall 12. Where the seat 14 transitions into the smaller bore portion 18, this transition can be gradual or abrupt as the seat 14 transitions into the smaller bore portion 18. The transition with the larger portion 16 can be similar. An abrupt transition is not problematic in that the perimeter seal 40 does not contact the seat 14 (or makes only limited contact) at these transitions between the seat 14 and the larger bore portion 16 and small bore portion 18.

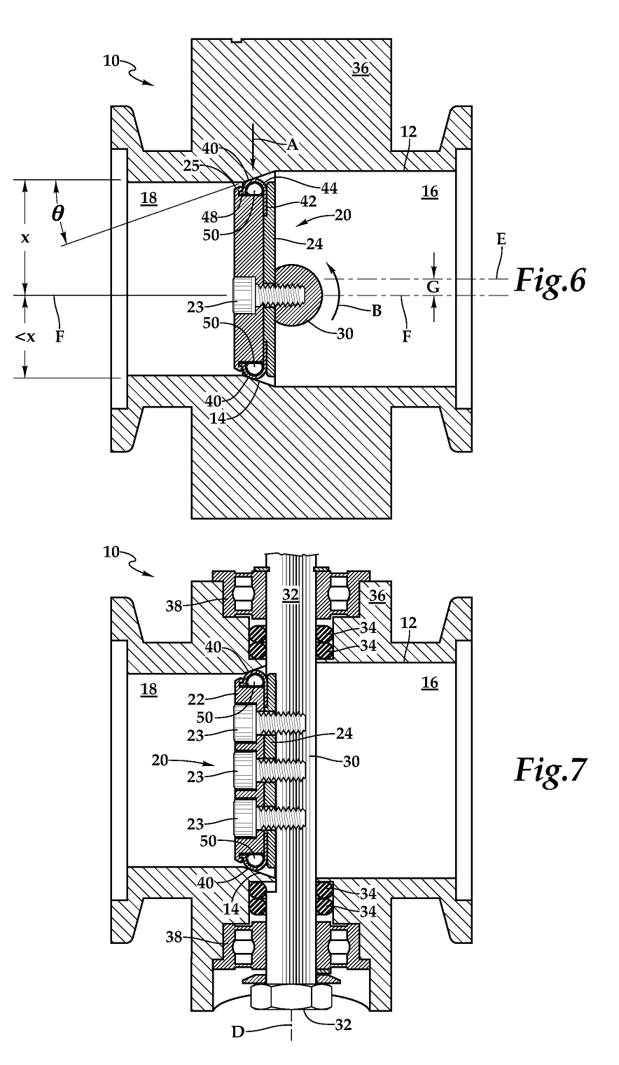

With continuing reference to FIGS. 1-8, particular details of the throttle plate 20 are described, according to the most preferred embodiment depicted herein. The throttle plate 20 provides a preferred form of valve plate and has a generally circular form with an annular perimeter edge. The throttle plate 20 pivots about a rotational axis D (FIG. 7) between an open position of the throttle plate (FIGS. 1, 2 and 4) with its perimeter spaced away from the body wall 12 and seat 14 of the valve 10, to a closed position (FIGS. 3 and 5-7) where the perimeter of the throttle plate 20 is brought into contact with the seat 14 and adjacent to portions of the smaller bore portion 18 of the body wall 12. While the open position (FIG. 1) is depicted with this throttle plate 20 in a most fully open position, in many instances an open position for the throttle plate 20 could include only slight opening (such as that depicted in FIGS. 2 and 4). The closed position for the throttle plate 20 would be similar to that depicted in FIGS. 3 and 5-7.

The throttle plate 20 is preferably formed of a front plate 22 and a rear plate 24 which each have a circular form and which are located adjacent to each other and parallel with each other. A seam between these plates 22, 24 is a flat surface without any gap therein, except that at a perimeter of this space between the plates 22, 24, a small gap 26 is provided. The small gap 26 is preferably provided by having the rear plate 24 exhibit a slightly lesser thickness adjacent to a perimeter edge thereof. The small gap 26 holds portions of the seal 40 described in detail below. Bolts 23 hold these plates 22, 24 of the throttle plate 20 together and also fasten the throttle plate 20 to a shaft 30 about which the throttle plate 20 pivots.

In this embodiment the front plate 22 is slightly thicker than the rear plate 24. Also, a perimeter edge of the front plate 22 has a slightly lesser diameter than that of the rear plate 24. Furthermore, the front side of the front plate 22 includes a lip 25 at a perimeter thereof. The lip 25 first extends radially outwardly from the perimeter edge of the front plate 22, and then extends rearwardly somewhat toward the rear plate 24. The lip 25 preferably has a constant cross-sectional form around an entire periphery of the front plate 22.

When the lip 25 transitions from extending radially from the perimeter of the front plate 22 to extending rearwardly toward the rear plate 24, this rearward extension is not directly toward the rear plate 24, but rather occurs with an outer surface of the lip 25 exhibiting a bevel 27 (FIG. 5) which exhibits an angle of approximately 15° away from a line perpendicular to the front surface of the front plate 22. This bevel 27 allows the lip 25 to just avoid (FIG. 4) contacting the seat 14 and the smaller bore portion 18 of the body wall 12 adjacent to the seat 14, when the throttle plate 20 is rotating into its closed position (along arrow B of FIG. 4). The lip 25 exhibits an overhang over a radial groove which can capture a portion of the seal 40, as described in detail below.

While the throttle plate 20 is shown as two separate plates 22, 24, this plate 20 could conceivably be formed from a single plate or from more than two plates. While the throttle plate 20 preferably has a circular perimeter with a diameter generally matching a circular dimension of the bore passing through the housing 36 of the valve 10, it is conceivable that the seat 14 and other portions of the bore passing through the housing 36 could have similar but non-circular forms that could be matched by the perimeter of the throttle plate 20, such as an oval form or a rounded square form or a rounded rectangle form, or other form, in which case the perimeter of the throttle plate 20 would be adjusted to match the contour of the body wall 12, to still function effectively according to this invention.

The throttle plate 20 pivots between its open position and its closed position. To facilitate such pivoting, the throttle plate 20 is mounted to a shaft 30. The shaft 30 is offset in two ways in this preferred embodiment. This offset shaft 30 has a central axis D (FIG. 7) and intersecting offset line F which is spaced from a centerline E of the bore 16, 18 passing through the housing 36 by an offset distance G. Also, the throttle plate 20 is mounted to the offset shaft 30 at a location on the throttle plate 20 spaced from a center point of the throttle plate 20. This offset of the shaft 30 away from the centerline E of the bore and of the shaft 30 away from the center point of the throttle plate 20 are identical in magnitude to each other. Thus, the center point of the throttle plate 20 remains upon the centerline E of the bore 16, 18 when the plate 20 is in a closed orientation. In one embodiment, this offset equals about 10% of a diameter of the bore 16, 18. This amount of offset could be less, potentially even being reduced to zero, but beneficially measures at least 5° and could be more than 10%, even up to 20% or even 30% of an average diameter of the bore 16, 18. This offset could be increased up to a maximum amount at which the throttle plate 20 can still avoid impacting the body wall 12 of the valve 10 when the throttle plate 20 is open enough to function adequately.

The offset shaft 30 is preferably a linear rigid structure which has the throttle plate 20 coupled thereto, through bolts 23 which pass through the plates 22, 24 of the throttle plate 20 and then into the offset shaft 30, such as into threaded holes which are parallel to each other and perpendicular to the central axis D of the offset shaft 30. Offset shaft 30 has an end 32 which extends through the body wall 12 and into the housing 36. Within the housing 36, preferably ring seals 34 are provided (FIG. 7) and with preferably multiple such ring seals (two being depicted at each end 32 of the shaft 30 in this embodiment) so that leakage of air (or other gas) is resisted from outside of the valve 10. Bearings 38 can optionally also be provided for rotational support of the offset shaft 30, such as at the ends 32 thereof.

With particular reference to FIGS. 4-7, details of the perimeter seal 40 are described, according to the most preferred embodiment of this invention. In this preferred embodiment, the seal 40 has a somewhat J-shaped cross-section. The seal 40 preferably has a radially symmetrical form as it extends circumferentially at the perimeter of the throttle plate 20. Considering the cross-section of the perimeter seal 40, it includes a long leg 42 which is substantially annular and planar, which fits within the gap 26 between the front plate 22 and rear plate 24 of the throttle plate 20. This long leg 42 transitions into an arch 44 which curves, preferably at a constant radius, 180° in a forward direction until it terminates at a tooth 48 which extends in a direction perpendicularly away from the long leg 42 at an end of the arch 44 opposite the long leg 42. This tooth 48 extend sufficiently far so that it can be captured in the annular groove beneath the lip 25 of the front plate 22. With this cross-sectional form, the perimeter seal 40 surrounds a recess 50 inboard of the arch 44. This recess 50 has a semi-circular cross-section and is generally in the form of a toroid extending around the perimeter of the throttle plate 20. The seal 40 has a wall which is preferably of constant thickness from the long leg 42 to the tooth 48.

The recess 50 of this invention could in one embodiment be entirely filled either with the same material forming the seal 40, or could be filled with some other material, such as a resilient material (e.g. rubber). The seal 40 is preferably formed from PTFE (poly-tetrafluoroethylene), or some other substance (examples including PEEK (poly-ether-ether-ketone), stainless steel, aluminum, or a fluoro elastomer such as FKM or FFKM) having desirable attributes for use in high-vacuum environments, including a seal 40 formed a very thin metal wall, or formed of other hydrocarbon materials or non-hydrocarbon materials which have desirable flexibility and resistance to gas penetration therethrough. By placing a resilient filling substance within the recess 50, the seal 40 can be thus energized according to one embodiment.

When the seal 40 is referred to as being “energized” what is meant is that when the seal 40 is compressed (along arrow A of FIGS. 5 and 6) by coming into contact with the seat 14, this compression is resisted by a resilient return force. In essence, energy is stored into this recess 50 (or the wall of the seal 40 (or both)) by an energy source located therein (or due to seal 40 material properties) when the seal 40 is compressed into the recess 50. This energy is available to apply a force keeping the seal 40 tightly in contact with the seat 14. This energy source is also available to return the seal 40 wall to its original form when the throttle plate 20 is rotated toward an open position, so that the seal 40 can again be energized when it is closed again in the future. In one embodiment, the seal 40 itself has a purposefully thick wall and is formed of a sufficiently resilient material that it acts as its own energy source and the seal 40 is thus energized, either with no recess 50, but the space being filled by the seal 40, or with the recess 50 being smaller due to the greater thickness of the wall of the seal 40 being present.

Most preferably, a separate energy source is provided within the recess 50. In one embodiment, this energy source is in the form of a toroidal spring 60. The toroidal spring 60 preferably has a helical form formed by a spring steel wire coiling helically as it extends in a toroidal fashion about an entire circuit adjacent to the perimeter of the throttle plate 20 and within the recess 50. Such a toroidal spring 60, when compressed laterally, stores up energy which can later be used to return the arch 44 of the seal 40 back to its original position when the seal 40 comes away from contact with the seat 14. Furthermore, when the spring 60 is compressed it stores up energy, but also is continually applying a force against the arch 44 of the seal 40, pressing the arch 44 of the seal 40 intimately against the seat 14, so that gas passage around the plate 20 and along the bore 16, 18 of the valve 10 is blocked.

Other forms of springs could alternatively be provided. As one alternative, a series of radially oriented center lines of linear helical compression springs could be provided which would each have a first end abutting a perimeter edge of the throttle plate 20 and a second end abutting an inside surface of the arch 44 of the seal 40. Such radially oriented helical compression springs would similarly both store energy when compressed and apply a force on the arch 44 of the seal 40 to keep the seal 40 in sealing contact with the seat 14.

With particular reference to FIG. 8, one vacuum handling system 100 utilizing the valve 10 of this invention is shown. In this system 100, the chamber 110 is provided upstream of the valve 10. A pump 120 is provided downstream of the valve 10. As the pump operates, gas flow occurs (along arrow C) out of the chamber 110, through the valve 10 and through the pump 120. Pressure within the chamber 110 is this reduced. The pressure sensor 130 within the chamber 110 monitors pressure therein. This pressure sensor 130 feeds information to a valve controller 140 which controls a rotational position of the throttle plate 20, by acting upon the shaft 30 to cause the shaft 30 to rotate and the corresponding throttle plate 20 to rotate, as needed to maintain optimal pressure.

As one example, when a pressure is attained within the chamber 110 which is at a desirably low level, the throttle plate 20 can transition to a closed orientation. In many instances, the vacuum pump 120 remains on to maintain the desired vacuum within the chamber 110. The valve 10 can transition between being fully closed (FIG. 3) to being at least partially open (FIG. 2) so that pressure control is maintained in the chamber 110 at a desired level. The fully open orientation for the valve 10 (FIG. 1) would generally be utilized when initially pumping down the chamber 110, and then transition between partially open (FIG. 2) and totally closed (FIG. 3), as common valve 10 orientations to provide desired vacuum while processes are performed within the chamber 110, and while the vacuum pump 120 continues to operate. Joint seals 150 join the valve 10 to adjacent structures within the vacuum system 100 so that air is prevented from leaking into the system 100.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A dynamically energized seal for a butterfly valve used in vacuum environments, comprising in combination:
a valve body including a cylindrical side wall;
said cylindrical side wall including a small bore portion and a large bore portion with a transition therebetween;
a throttle plate located within said large bore and adjacent said transition;
said throttle plate including a rotational hub and a perimeter;
said perimeter including a seal thereon having a J-shaped cross-section including a long leg and a short leg with a semi-circular section therebetween;
said long leg and said short leg each captured to said throttle plate; and
said J-shaped seal energized by at least one energy source inboard of said semi-circular section of said seal.

2. The seal of claim 1 wherein said energy source includes at least one spring at least partially surrounded by said semi-circular section of said seal.

3. The seal of claim 2 wherein said spring is a toroidal spring.

4. The seal of claim 3 wherein said seal is formed of PTFE.

5. The seal of claim 1 wherein said seal on said perimeter of said throttle plate is located an equal distance from a center point of said throttle plate, said throttle plate having a circular form about said center point, said throttle plate mounted to a rotating shaft, said rotating shaft offset from said center point, and said shaft mounted to said valve body along a shaft central axis which is spaced from a centerline of said small bore portion and said large bore portion.

6. A valve having an energized seal, the valve comprising in combination:
a bore passing through a valve body, said bore having a seat on a surface thereof defining a transition between a larger bore portion and a smaller bore portion;
a valve plate pivotably attached at a location adjacent to said seat;
said valve plate having a closed position with a perimeter of said valve plate abutting said seat;
said valve plate having an open position leaving said valve plate at least partially spaced from said seat;
a seal on said valve plate adjacent to said perimeter, said seal contacting said seat when said valve plate is in said closed position; and
said seal having a wall outside of a recess, said seal energized away from said recess to securely contact said seat when said valve plate is in said closed position.

7. The valve of claim 6 wherein said valve plate is coupled to a shaft having a central axis about which said valve plate pivots.

8. The valve of claim 7 wherein said shaft is offset from a center of said bore, and wherein said valve plate is coupled to said shaft at a location offset from a center of said valve plate.

9. The valve of claim 6 wherein said seal is energized at least partially by said seal being formed of resilient material that exerts a sealing force when said seal is compressed from an original position toward said recess and resiliently applies a force tending to return said seal to original uncompressed form.

10. The valve of claim 6 wherein said seal is energized by said recess having at least one spring located therein.

11. The valve of claim 10 wherein said spring is a toroidal spring located within said recess, and wherein said recess forms a circuit substantially circumscribing said perimeter of said valve plate.

12. The valve of claim 11 wherein said seal has a wall with a J-shaped cross-section including a long leg transitioning into a semi-circular section which transitions into a tooth, said long leg and said tooth captured to said perimeter of said valve plate, with said semi-circular section surrounding said recess, and leaving said recess having a semi-circular cross-sectional form inboard of said wall.

13. The valve of claim 12 wherein said valve plate includes a front plate and a rear plate which are parallel to each other and locate adjacent to each other, a gap between said front plate and said rear plate at a perimeter joint therebetween, said gap including at least portions of said long leg of said seal therein, said front plate including a lip and a perimeter edge thereof which extends first radially outwardly and then toward said rear plate, said lip capturing said tooth of said seal to said valve plate.

14. A vacuum valve, the valve comprising in combination:
a bore passing through a valve body, said bore having a seat on a surface thereof defining a transition between a larger bore portion and a smaller bore portion;
a valve plate pivotably attached at a location adjacent to said seat;
said valve plate having a closed position with a perimeter of said valve plate abutting said seat;
said valve plate having an open position leaving said valve plate at least partially from said seat;
a seal on said valve plate adjacent to said perimeter, said seal contacting said seat when said valve plate is in said closed position;
wherein said valve plate is coupled to a shaft having a central axis about which said valve plate pivots; and
wherein said shaft is offset from a center of said bore, and wherein said valve plate is coupled to said shaft at a location offset from a center of said valve plate.

15. The valve of claim 14 wherein said seal having a wall outside of a recess, said seal energized away from said recess to securely contact said seat when said valve plate is in said closed position.

16. The valve of claim 15 wherein said seal is energized at least partially by said seal being formed of resilient material that exerts a sealing force when said seal is compressed from an original position toward said recess and resiliently applies a force tending to return said seal to original uncompressed form.

17. The valve of claim 15 wherein said seal is energized by said recess having at least one spring located therein.

18. The valve of claim 17 wherein said spring is a toroidal spring located within said recess.

19. The valve of claim 18 wherein said seal has a wall with a J-shaped cross-section including a long leg transitioning into a semi-circular section which transitions into a tooth, said long leg and said tooth captured to said perimeter of said valve plate with said semi-circular section surrounding said recess, and leaving said recess having a semi-circular cross-sectional form inboard of said wall.

20. The valve of claim 19 wherein said valve plate includes a front plate and a rear plate which are parallel to each other and locate adjacent to each other, a gap between said front plate and said rear plate at a perimeter joint therebetween, said gap including at least portions of said long leg of said seal therein, said front plate including a lip and a perimeter edge thereof which extends first radially outwardly and then toward said rear plate, said lip capturing said tooth of said seal to said valve plate.
